(19) United States
(12) Patent Application Publication
(10) Pub. No.: US 2026/0261690 A1
(43) Pub. Date: Sep. 3, 2026

(54) LOW-COMPLEXITY ENHANCMENT VIDEO CODING USING TILE-LEVEL QUANTIZATION PARAMETERS

(71) Applicant: Intel Corporation, Santa Clara, CA (US)

(72) Inventors: Huijuan Zhou, Shanghai (CN); Jing Li, Shanghai (CN); Renzhi Jiang, Shanghai (CN); Yi Wang, Shanghai (CN); Chenchen Wang, Shanghai (CN)

(73) Assignee: Intel Corporation, Santa Clara, CA (US)

(21) Appl. No.: 18/995,676

(22) PCT Filed: Sep. 29, 2022
(86) PCT No.: PCT/CN2022/122818

§ 371 Date: Jan. 16, 2025

(51) Int. Cl. H04N 19/196; H04N 19/132; H04N 19/187; H04N 19/33; H04N 19/44; H04N 19/70

(52) U.S. Cl. CPC H04N 19/196; H04N 19/132; H04N 19/187; H04N 19/33; H04N 19/44; H04N 19/70

(57) ABSTRACT

This disclosure describes systems, methods, and devices related to decoding low-complexity enhancement video coding (LCEVC) video data. A device may receive a bitstream including a first layer and enhancement layers; decode a video frame of the first layer of the bitstream using a base decoder; up-sample the decoded video frame; decode the video frame of a first enhancement layer using tile-level quantization parameters; generate a first combined intermediate video frame using the up-sampled video frame and the decoded video data of the first enhancement layer; up-sample the first combined intermediate video frame; decode encoded video data of a second enhancement layer; generate a second combined intermediate video frame using the decoded video data of the second enhancement layer and a selected reference frame; and generate a combined output video frame using the first combined intermediate video frame and the second combined intermediate video frame.

### TECHNICAL FIELD

This disclosure generally relates to systems and methods for video coding and, more particularly, to Low-Complexity Enhancement Video Coding.

### BACKGROUND

LCEVC (Low-Complexity Enhancement Video Coding) encodes video at a lower resolution version of a source image using any existing codec, and the difference between the reconstructed lower resolution image and the source using a different compression method. However, LCEVC is limited to video frame-level quantization parameters.

### BRIEF DESCRIPTION OF THE DRAWINGS

FIG. 1 is an example block diagram of a Low-Complexity Enhancement Video Coding (LCEVC) decoder, according to some example embodiments of the present disclosure.

FIG. 2A illustrates example LCEVC using same quantization parameters across all tiles of a video frame, according to some example embodiments of the present disclosure.

FIG. 2B illustrates example LCEVC using tile-based quantization parameters for a video frame, according to some example embodiments of the present disclosure.

FIG. 3 is an example block diagram of a LCEVC encoder, according to some example embodiments of the present disclosure.

FIG. 4 illustrates a flow diagram of an illustrative process for LCEVC using tile-level quantization parameters, in accordance with one or more example embodiments of the present disclosure.

FIG. 5 illustrates an embodiment of an exemplary system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

LCEVC (Low-Complexity Enhancement Video Coding) works by encoding a lower resolution version of a source image using any existing codec (e.g., the base codec, such as AVC, HEVC, VP9, AV1, etc.), and encoding the difference between the reconstructed lower resolution image and the source image using a different compression method (e.g., the enhancement). LCEVC is an enhancement codec, meaning that it does not only up-sample well, it also encodes the residual information necessary for true fidelity to the source video and compresses the information (e.g., transforming, quantizing and coding the information).

LCEVC residual layers (e.g., enhancement sub-layers) encode the residual information necessary for true fidelity to the source video and compress the information (e.g., transforming, quantizing, and coding it). LCEVC can be used in higher resolutions or higher frame rates (e.g., 4Kp60, 8K, 12K) of video encoding, adaptive video streaming, and the like. LCEVC supports a temporal layer in a layer-two (L-2) enhancement layer to improve the BD-Rate (Bjontegaard rate difference), which gives a temporal mask to indicate INTRA_PRED or INTER_PRED information per transform block (e.g., whether the block was coded using intra or inter prediction). The transform block could be either 2x2 or 4x4, for example. If the temporal mask of the block is INTER_PRED, only the residual delta (e.g., residual of the current L-2 enhancement layer-reconstructed residual of previous L-2 enhancement layer) is encoded.

With the popularization of 4K/8K ultra-high-definition displays, various industries have an increasing demand for ultra-high-definition images and a growing number of application scenarios. LCEVC can be used in higher resolutions or higher frame rates (e.g., 4Kp60, 8K, 12K) video encoding, adaptive video streaming, 360video, multi-view video, light-field video, etc. Many of these video streaming applications require appropriate rate control techniques that make use of the specific characteristics of the video content, such as the regions of interest (ROI). ROI- and tile-based rate control algorithms are introduced in higher resolutions video encoding, panoramic streaming, etc.

ROI encoding accounts for certain regions within a video frame being of more interest/importance to a viewer (e.g., due to an object being presented in a ROI, due to motion in an ROI, etc.). In ROI encoding, a video encoder may encode ROIs with less compression than non-ROIs. The ROIs may be designated by numbers representing pixel locations within a video frame. An encoded bitstream may indicate the pixel locations corresponding to ROIs. In this manner, some tiles of a video frame may be within the ROIs, and some tiles may be non-ROIs.

The current temporal layer implementation in the LCEVC standard only supports video frame-level quantization parameters (QPs), but not tile/block-level QPs, so LCEVC cannot use the ROI information. The quantization uses a quantization matrix which includes step widths (e.g., quantization step sizes) to be used to decode each coefficient group. Quantization of residuals/coefficients may be performed on bins having a defined step width. Quantization parameters control the amount of compression to apply, and a larger quantization parameter results in more compression. For the calculation of the quantization matrix, default coefficients are preset in LCEVC, and custom coefficients also can be signaled in the bitstream modifying the quantization process on a frame-by-frame basis. Take a 2x2 transformation for the residuals of enhancement sub-level 2 as example. The residuals are transformed and parsed into layers. Different tiles for each layer may have the same QP in quantization. There is no feasible tile/block QP in LCEVC.

There is therefore a need for enhanced LCEVC encoding by extending the syntax in LCEVC tile dimensions to support a tile-level step width update to achieve the purpose of adjusting the QP.

In one or more embodiments, enhanced LCEVC may leverage tiles in LCEVC and extend delta QP in tiles. Tile encoding may include dividing a video frame into tiles that may be encoded and decoded independently (e.g., in parallel, using multiple encoders/decoders). To enable tile-level QPs (e.g., QPs that apply to a particular tile of a video frame rather than to an entire video frame), enhanced LCEVC may use a new syntax flag delta_qp_per_tile_flag for tiles in a process_payload_global_config (e.g., the global configuration for the bitstream) in the LCEVC bitstream, as shown below in Tables 1A and 1B. The new syntax may enable delta QP information in “process_payload_encoded_data_tiled.” The new syntax structure for tiles may represent an extension of the LCEVC encoding process, providing a switch to enable/disable delta QPs and to adjust QP value for different tiles. So, there may be no increase of encoding and decoding complexity.

TABLE 1A
Payload ‘process_payload_global_config ( )’
in LCEVC Bitstream process_block syntax:

| Syntax | Descriptor |
|---|---|
| process_payload_globa | |
| l_config(payload_size) { | |
| processed_planes_typ | u(1) |
| e_flag | |
| ...... | ...... |
| if | |
| (tile_dimensions_type > 0) { | |
| if | |
| (tile_dimensions_type == 3) { | |
| custom_tile_width | u(16) |
| custom_tile_height | u(16) |
| } | |
| reserved_zeros_5bit | u(5) |
| compression_type_ent | u(1) |
| ropy_enabled_per_tile_flag | |
| compression_type_siz | u(2) |
| e_per_tile | |
| } | |
| ...... | |
| } | |

Using one of the five reserved bits u(5) from Table 1A to add the delta_qp_per_tile_flag may result in the global configuration payload shown in Table 1B below.

TABLE 1B
Adding delta_qp_per_tile_flag to Payload
‘process_payload_global_config ( )’ in LCEVC
Bitstream process_block syntax:

| Syntax | Descriptor |
|---|---|
| process_payload_global_config(payload_size) { | |
| processed_planes_type_flag | u(1) |
| ...... | ...... |
| if (tile_dimensions_type > 0) { | |
| if (tile_dimensions_type == 3) { | |
| custom_tile_width | u(16) |
| custom_tile_height | u(16) |
| } | |
| reserved_zeros_4bit | u(4) |
| compression_type_entropy_enabled_per_tile_flag | u(1) |
| compression_type_size_per_tile | u(2) |
| delta_qp_per_tile_flag | u(1) |
| } | |
| ...... | |
| } | |

In one or more embodiments, when tile_dimensions_type is greater than one, the encoder can enable/disable delta_qp_per_tile_flag. In addition, Table 2 below shows the available value of delta_qp_per_tile_flag. Table 3 below shows the details of process payload of encoded tiled data.

TABLE 2
Enabled/Disable Delta QP in Video Tile:

| delta_qp_per_tile_flag | Value of type |
|---|---|
| 0 | Disable delta QP in tile |
| 1 | Enable delta QP in tile |

TABLE 3
Process Payload - Encoded Tiled Data:

| Syntax | Descriptor |
|---|---|
| process_payload_encoded_data_tiled(payload_size) { | |
| for (planeIdx = 0; planeIdx < nPlanes; planeIdx++) { | |
| for (levelIdx = 1; levelIdx <= 2; levelIdx++) { | |
| if (no_enhancement_bit_flag == 0) { | |
| for (layerIdx = 0; layerIdx < nLayers;layerIdx++) | |
| surfaces[planeIdx][levelIdx][layerIdx].rle_only_flag | u(1) |
| } | |
| } | |
| if (temporal_signalling_present_flag == 1) | |
| temporal_surfaces[planeIdx].rle_only_flag | u(1) |
| } | |
| byte_alignment( ) | |
| if (delta_qp_per_tile_flag == 1) { | |
| for (planeIdx = 0; planeIdx < nPlanes; planeIdx++) { | |
| if (no_enhancement_bit_flag == 0) { | |
| for (levelIdx = 1; levelIdx <= 2; levelIdx++) { | |
| if (levelIdx == 1 && step_width_level1_enabled_flag == 1) | |
| nTiles = nTilesL1 | |
| else if(levelIdx == 2 && step_width_level2_enabled_flag == 1) | |
| nTiles = nTilesL2 | |
| else | |
| nTiles = 0 | |
| for (layerIdx = 0; layerIdx < nLayers; layerIdx++) { | |
| for (tileIdx = 0; tileIdx < nTiles; tileIdx++) | |
| tile_QP_delta | u(15) |
| } | |
| } | |
| } | |
| } | |
| } | |
| byte_alignment( ) | |
| if (compression_type_entropy_enabled_per_tile_flag == 0) { | |
| for (planeIdx = 0; planeIdx < nPlanes; planeIdx++) { | |
| if (no_enhancement_bit_flag == 0) { | |
| for (levelIdx = 1; levelIdx <= 2; levelIdx++) { | |
| if (levelIdx == 1) | |
| nTiles = nTilesL1 | |
| else | |
| nTiles = nTilesL2 | |
| for (layerIdx = 0; layerIdx < nLayers; layerIdx++) { | |
| for (tileIdx = 0; tileIdx < nTiles; tileIdx++) | |
| surfaces[planeIdx][levelIdx][layerIdx].tiles[tileIdx]. | u(1) |
| entropy_enabled_flag | |
| } | |
| } | |
| } | |
| if (temporal_signalling_present_flag == 1) { | |
| for (tileIdx = 0; tileIdx < nTilesL2; tileIdx++) | |
| temporal_surfaces[planeIdx].tiles[tileIdx].entropy_enabled_flag | u(1) |
| } | |
| } | |
| } else { | |
| entropy_enabled_per_tile_compressed_data_rle | mb |
| } | |
| ...... | |
| } | |

In one or more embodiments, the step width (stepWidth) is one of the inputs for the dequantization process. QP can be expressed by the step width based on Equation (1):

$$Q P = f ( step\_width ) . \qquad ( 1 )$$

In one or more embodiments, the step width may be updated for each enhancement sub-level (e.g., step_width_level1 and step_width_level2) with step_width_tile for each tile to dequantize the entropy decoded quantized transform coefficient. The stepwidth value of the tile step_width_tile may be derived based on Equation (2):

$$step\_width \_tile = clip 3 ( 0 , ( {2}^{15} - 1 ) , step\_width \_levelN + ( tile\_QP \_delta - {2}^{14} ) ) , \qquad ( 2 )$$

where step_width_levelN specifies the value of the step width value to be used when decoding the encoded residuals in enhancement sub-level N (1 or 2), which is defined in the process payload of picture configuration. The value of step_width_tile may be in the range of 0 to 2¹⁵-1.

In one or more embodiments, below is an example pseudo code for step_width_tile updating by tile_QP_delta:

```
  step_width_tile[2][nLayers][nTiles] ####store step_width of each layer and each tile
for each level residuals
  if (delta_qp_per_tile_flag == 1) {
  for (planeIdx = 0; planeIdx < nPlanes; planeIdx++) {
  if (no_enhancement_bit_flag == 0) {
      for (levelIdx = 1; levelIdx <= 2; levelIdx++) {
          if (levelIdx == 1 && step_width_level1_enabled_flag == 1)
              nTiles = nTilesL1
          else if(levelIdx == 2 && step_width_level2_enabled_flag == 1)
              nTiles = nTilesL2
  else
  nTiles = 0
            for (layerIdx = 0; layerIdx < nLayers; layerIdx++) {
                for (tileIdx = 0; tileIdx < nTiles; tileIdx++)
                    step_width_tile[levelIdx][layerIdx][tileIdx] = clip3(0, (2¹⁵-1),
step_width_levelN +( tile_QP_delta - 2¹⁴))
                  }
            }
        }
    }
```

In one or more embodiments, enhanced LCEVC may be more flexible and can achieve good performance in video transmission applications which have Regions of Interest (ROI) information by setting different QPs for different tiles (e.g., including different tiles in a same video frame). The QP regulates how much spatial detail is saved. For the tiles which have ROI, QP is set as a small number so that almost all that detail is retained (e.g., compress ROI tiles less than non-ROI tiles to preserve ROI video data). While in other non-ROI tiles, QP is increased, and some of that detail is aggregated so that the bit rate drops, but at the price of some increase in distortion and some loss of quality.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

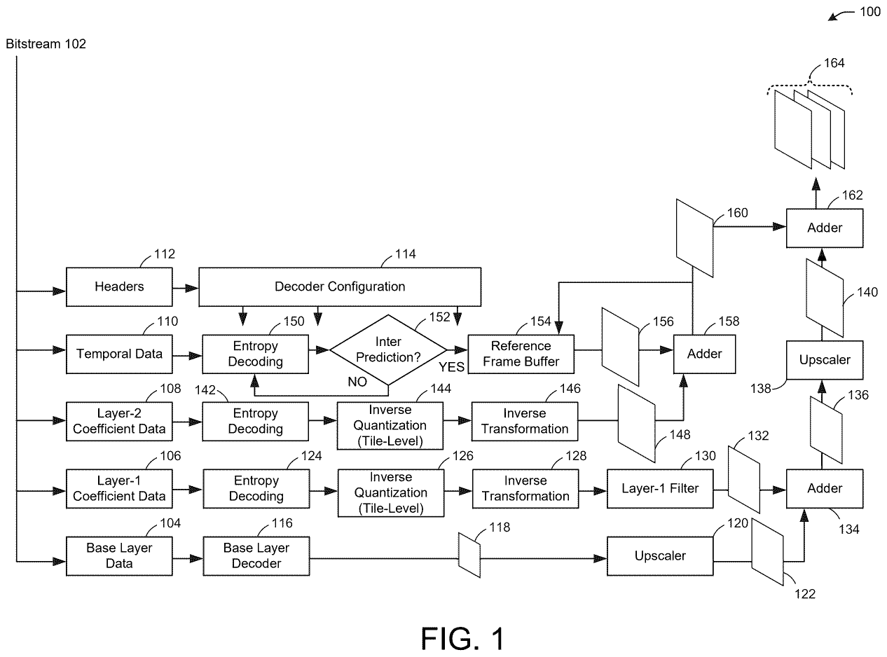

FIG. 1 is an example block diagram of a Low-Complexity Enhancement Video Coding (LCEVC) decoder 100, according to some example embodiments of the present disclosure.

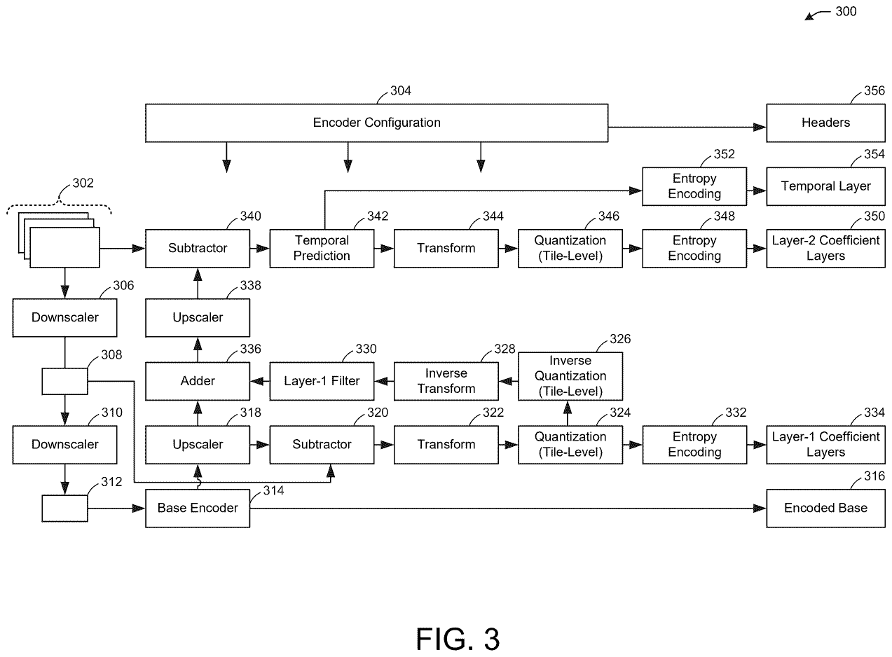

Referring to FIG. 1, the LCEVC decoder 100 may receive a bitstream 102 (e.g., an encoded bitstream as generated by the LCEVC encoder 300 of FIG. 3) having multiple layers (e.g., a base layer and enhancement layers). Frames encoded at the base layer of the bitstream 102 may include base layer data 104. Frames encoded an a first enhancement layer (e.g., Layer-1) may include Layer-1 coefficient data 106. Frames encoded at a second enhancement layer (e.g., Layer-2) may include Layer-2 coefficient data 108. Frames encoded at a temporal layer may include temporal data 110. Headers 112 of the bitstream 102 may be input to a decoder configuration 114 used by the LCEVC decoder 100. The layers of the bitstream and the ways that they are encoded are explained below with respect to FIG. 6.

Still referring to FIG. 1, the base layer data 104 may be decoded by a base layer decoder 116 (e.g., a non-LCEVC decoder), resulting in a decoded base layer frame 118. An upscaler 120 may up-sample (e.g., increase the pixel count of the image) the decoded base layer frame 118, resulting in an up-sampled base layer frame 122 (e.g., a preliminary intermediate frame). The Layer-1 coefficient data 106 may be decoded using an entropy decoder 124, and inverse quantization 126 using tile-level QPs may be performed on the decoded Layer-1 coefficient data to identify the transform coefficients. Inverse transformation 128 may determine the transform used to generate the Layer-1 coefficient data 106. The Layer-1 data that has been inversely transformed may pass through a Layer-1 filter 130 to generate a Layer-1 decoded frame 132. The Layer-1 decoded frame 132 and the up-sampled base layer frame 122 may be added by an adder 134 to generate a combined intermediate frame 136. The combined intermediate frame 136 may be up-sampled by an upscaler 138 to generate a combined intermediate frame 140 at full resolution.

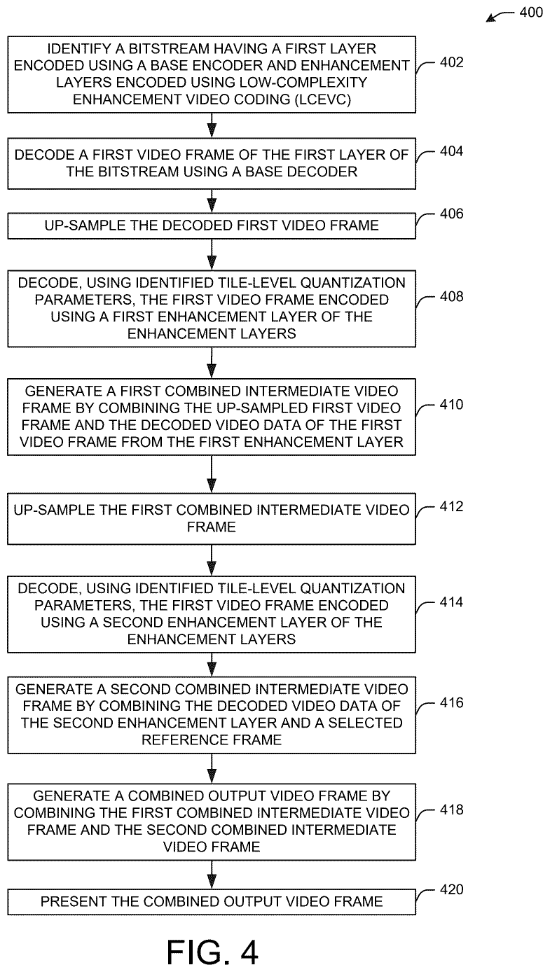

Still referring to FIG. 4, the Layer-2 coefficient data 108 may be decoded using an entropy decoder 142, and inverse quantization 144 using tile-level QPs may be performed on the decoded Layer-2 coefficient data to identify the transform coefficients. Inverse transformation 146 may determine the transform used to generate the Layer-2 coefficient data 108. The Layer-2 data that has been inversely transformed may generate Layer-2 residuals 148. The temporal data 110 may be decoded using an entropy decoder 150. When inter prediction 152 was used (e.g., as indicated by the syntax of the bitstream 102), only the Layer-2 residuals 148 may be decoded. The decoded temporal data may be compared to a reference frame in a reference frame buffer 154. The reference frame buffer 154 may store one or multiple reference frames at a given time, allowing the LCEVC decoder 100 to select one of the references frames (e.g., the best matching reference frame for the given frame being decoded) to combine with the decoded temporal data to generate an intermediate frame 156. The intermediate frame 156 may be combined with the Layer-2 residuals 148 at an adder 158 to generate a combined intermediate frame 160. The combined intermediate frame 160 and the combined intermediate frame 140 may be combined by an adder 162 to generate a combined output video frame. The combined output video frames 164 of the LCEVC decoder 100 may be presented for playback.

In one or more embodiments, to enable tile-level QPs (e.g., at the inverse quantization 126 and the inverse quantization 144), the bitstream 102 may use a new syntax flag delta_qp_per_tile_flag for tiles in a process_payload_global_config (e.g., the global configuration), as shown above Table 1B. The new syntax may enable delta QP information in “process_payload_encoded_data_tiled.” The new syntax structure for tiles may represent an extension of the LCEVC encoding process, providing a switch to enable/disable delta QPs and to adjust QP value for different tiles. So, there may be no increase of encoding and decoding complexity.

In one or more embodiments, when tile_dimensions_type in the syntax of the bitstream 102 is greater than one, the decoder can enable/disable delta_qp_per_tile_flag. In addition, Table 2 above shows the available value of delta_qp_per_tile_flag. Table 3 above shows the details of process payload of encoded tiled data. As shown in Table 2, when the delta_qp_per_tile_flag is 0, tile-level delta QPs may be disabled, and when the delta_qp_per_tile_flag is 1, tile-level delta QPs may be enabled, indicating to the LCEVC decoder 200 whether the inverse quantization uses QPs at the tile-level or not. As shown in Table 3, when the delta_qp_per_tile_flag is 1, for each layer of a video frame of the bitstream 102, there may be a respective QP (e.g., tile_QP_delta) to apply for inverse quantization. The QP for the respective tile of a video frame of the bitstream 102 may be a function of the step_width according to Equation (1) above. For each LCEVC enhancement layer and, each tile may have a step_width_tile for each tile to inversely quantize (dequantize) the decoded quantized transform coefficient. The step_width_tile for each tile is based on Equation (2) above.

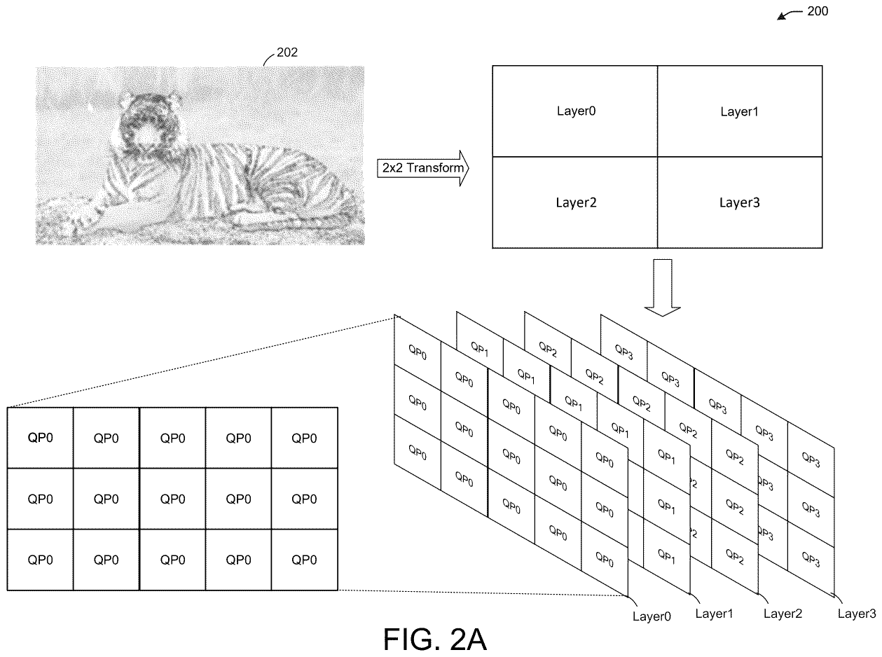

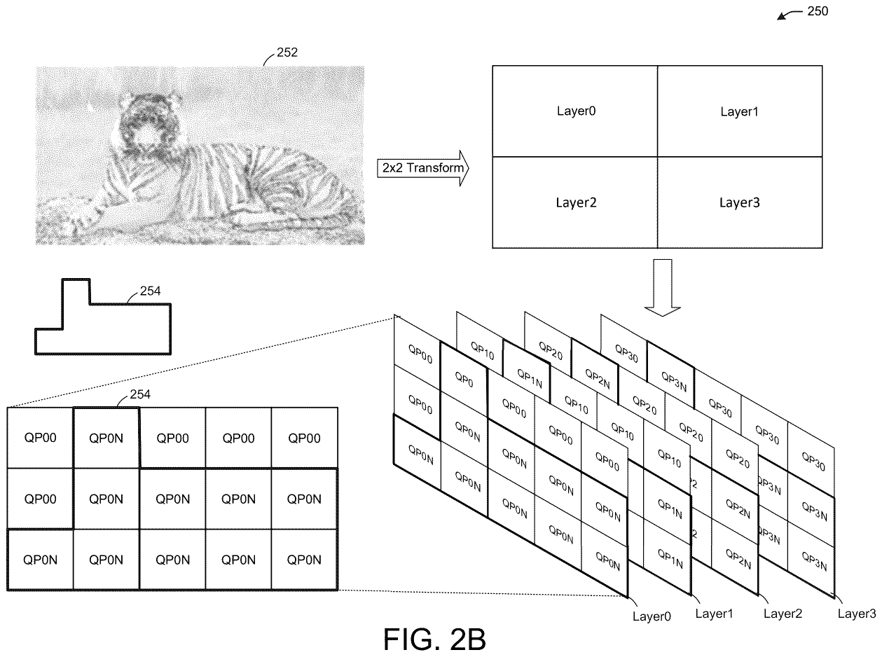

FIG. 2A illustrates example LCEVC 200 using same quantization parameters across all tiles of a video frame, according to some example embodiments of the present disclosure.

Referring to FIG. 2A, a video frame 202 (e.g., representing a tiger) may be transformed using a transform (e.g., a 2x2 transform), resulting in the video frame 202 being divided into four layers (e.g., layer0, layer1, layer2, layer3). Each tile of each layer of the video frame 202 may be quantized using a tile-level QP (e.g., QP0 for layer0, QP1 for layer1, QP2 for layer2, QP3 for layer3). Even though some tiles of the video frame 202 in which portions of the tiger are shown may be considered ROIs, the LCEVC 200 may not vary the QPs for the tiles of the video frame 202.

FIG. 2B illustrates example LCEVC 250 using tile-based quantization parameters for a video frame, according to some example embodiments of the present disclosure.

Referring to FIG. 2B, (e.g., representing a tiger) may be transformed using a transform (e.g., a 2x2 transform), resulting in the video frame 252 being divided into four layers (e.g., layer0, layer1, layer2, layer3). Each tile of each layer of the video frame 252 may be quantized using a tile-level QP (e.g., QP00 for layer0 non-ROI tiles, QPON for a different QP of layer0 ROI tiles corresponding to where the tiger or other object of interest are—where N may be different for any given tile, QP10 for layer1 non-ROI tiles, QPIN for a different QP of layer1 ROI tiles corresponding to where the tiger or other object of interest are—where N may be different for any given tile, QP20 for layer2 non-ROI tiles, QP2N for a different QP of layer2 ROI tiles corresponding to where the tiger or other object of interest are—where N may be different for any given tile, QP30 for layer3 non-ROI tiles, QP3N for a different QP of layer3 ROI tiles corresponding to where the tiger or other object of interest are—where N may be different for any given tile). Tiles that are part of ROIs 254 (e.g., the regions of the video frame252 in which the tiger is represented as an object of interest) may be quantized differently than non-ROI tiles. In this manner, the tiles (e.g., rectangles as shown) corresponding to the ROIs 254 of the video frame 252 may use different QPs than the non-ROI tiles, allowing the ROI tiles to be compressed less than the non-ROI tiles, for example.

In contrast with FIG. 2A, the LCEVC 250 of FIG. 2B allows for tile-level QPs so that ROI tiles (e.g., tiles of the video frame 252 in which portions of the tiger are represented) may be quantized with different QPs than non-ROI tiles of the video frame 252.

In one or more embodiments, to enable tile-level QPs (e.g., the QPXY as shown, where X is the layer, and Y is the QP for the layer) of the LCEVC 250 of FIG. 2B, the bitstream 102 of FIG. 1 may use a new syntax flag delta_qp_per_tile_flag for tiles in a process_payload_global_config (e.g., the global configuration), as shown above Table 1B. The new syntax may enable delta QP information in “process_payload_encoded_data tiled.” The new syntax structure for tiles may represent an extension of the LCEVC encoding process, providing a switch to enable/disable delta QPs and to adjust QP value for different tiles. So, there may be no increase of encoding and decoding complexity.

In one or more embodiments, when tile_dimensions_type in the syntax of the bitstream 102 is greater than one, the decoder can enable/disable delta_qp_per_tile_flag. In addition, Table 2 above shows the available value of delta_qp_per_tile_flag. Table 3 above shows the details of process payload of encoded tiled data. As shown in Table 2, when the delta_qp_per_tile_flag is 0, tile-level delta QPs may be disabled, and when the delta_qp_per_tile_flag is 1, tile-level delta QPs may be enabled, indicating to the LCEVC decoder 200 whether the inverse quantization uses QPs at the tile-level or not. As shown in Table 3, when the delta_qp_per_tile_flag is 1, for each layer of a video frame of the bitstream 102, there may be a respective QP (e.g., tile_QP_delta) to apply for inverse quantization. The QP for the respective tile of a video frame of the bitstream 102 may be a function of the step_width according to Equation (1) above. For each LCEVC enhancement layer and, each tile may have a step_width_tile for each tile to inversely quantize (dequantize) the decoded quantized transform coefficient. The step_width_tile for each tile is based on Equation (2) above.

FIG. 3 is an example block diagram of a LCEVC encoder 300, according to some example embodiments of the present disclosure.

Referring to FIG. 3, the LCEVC encoder 300 may generate the bitstream 102 of FIG. 1. An input sequence 302 of video frames may be used to generate the bitstream 102 using an encoder configuration 304. The input sequence 302 may be down-sampled by a downscaler 306 to generate a downscaled frame 308, which may be down-sampled further by a downscaler 310 to generate a downscaled frame 312. The downscaled frame 312 may be encoded by a base encoder 314 (e.g., a non-LCEVC encoder) to generate an encoded base 316 (e.g., the base layer of the bitstream 102 used for the base layer data 104 of FIG. 1). The encoded frame from the based encoder 314 may be up-sampled by an upscaler 318 and subtracted from the downscaled frame 308 by a subtractor 320 to generate Layer-1 residuals on which a transform 322 and quantization 324 (e.g., using tile-level QPs) may be performed (e.g., for reconstruction). The transformed and quantized Layer-1 data may be used for inverse quantization 326 and inverse transform 328 (e.g., to reconstruct the pixel data), and passed through a Layer-1 filter 330. The quantized Layer-1 data from the quantization 324 may produce the Layer-1 coefficient layers 334 for the bitstream 102. The filtered Layer-1 data may be added to the up-sampled frame from the upscaler 318 by an adder 336 to generate an intermediate frame, which may be up-sampled again by an upscaler 338. A frame from the input sequence 302 may be subtracted from the intermediate frame by a subtractor 340 to generate Layer-2 residuals input for temporal prediction 342. Transform 344 and quantization 346 (e.g., using tile-level QPs) may be performed on the temporal prediction 342, which then may be entropy encoded 348 to generate Layer-2 coefficient layers 350 for the bitstream 102. The temporal prediction 342 data may be entropy encoded 352 to generate the temporal layer 354 of the bitstream 102. The encoder configuration 304 may be indicated in the headers 356 of the bitstream 102 syntax.

Referring to FIGS. 1 and 3, a subtractor may generate a residual as explained further herein. Transform and quantization may generate and quantize transform units to facilitate encoding by a coder (e.g., entropy coder). Transform and quantized data may be inversely transformed and inversely quantized by an inverse transform and quantizer on the decoder side. An adder may compare the inversely transformed and inversely quantized data to a prediction block generated by a prediction unit (e.g., temporal prediction), resulting in reconstructed frames. A filter (e.g., in-loop filter for resizing/cropping, color conversion, de-interlacing, composition/blending, etc.) may revise reconstructed frames from an adder, and may store the reconstructed frames in an image buffer (e.g., the reference frame buffer 154 of FIG. 1). A control may manage many encoding aspects (e.g., parameters) including at least the setting of a quantization parameter (QP), but could also include setting bitrate, rate distortion or scene characteristics, prediction and/or transform partition or block sizes, available prediction mode types, and best mode selection parameters, for example, based at least partly on data from the prediction unit. Using the encoding aspects, the transform and quantization processes may generate and quantize transform units to facilitate encoding by the coder, which may generate coded data that may be transmitted (e.g., an encoded bitstream).

Still referring to FIGS. 1 and 3, inverse transform and quantization may reconstruct pixel data based on the quantized residual coefficients and context data. An adder may add the residual pixel data to a predicted block generated by a prediction unit. A filter may filter the resulting data from the adder. The filtered data may be output by a media output, and also may be stored as reconstructed frames in an image buffer (e.g., the reference frame buffer 154 of FIG. 1) for use by the prediction unit.

Referring to FIGS. 1 and 3, the LCEVC decoder 100 and encoder 300 performs the methods of intra prediction disclosed herein, and is arranged to perform at least one or more of the implementations described herein including intra block copying. In various implementations, the LCEVC decoder 100 and encoder 300 may be configured to undertake video coding and/or implement video codecs according to one or more standards. Further, in various forms, LCEVC decoder 100 and encoder 300 may be implemented as part of an image processor, video processor, and/or media processor and undertakes inter-prediction, intra-prediction, predictive coding, and residual prediction. In various implementations, LCEVC decoder 100 and encoder 300 may undertake video compression and decompression and/or implement video codecs according to one or more standards or specifications, such as, for example, H.264 (Advanced Video Coding, or AVC), VP8, H.265 (High Efficiency Video Coding or HEVC) and SCC extensions thereof, VP9, Alliance Open Media Version 1 (AV1), H.266 (Versatile Video Coding, or VVC), DASH (Dynamic Adaptive Streaming over HTTP), and others.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder. An encoder may have a decoder loop as described below.

For example, the LCEVC encoder 300 may be an encoder where current video information in the form of data related to a sequence of video frames may be received to be compressed. By one form, a video sequence is formed of input frames of synthetic screen content such as from, or for, business applications such as word processors, power points, or spread sheets, computers, video games, virtual reality images, and so forth. By other forms, the images may be formed of a combination of synthetic screen content and natural camera captured images. By yet another form, the video sequence only may be natural camera captured video. A partitioner may partition each frame into smaller more manageable units, and then compare the frames to compute a prediction. If a difference or residual is determined between an original block and prediction, that resulting residual is transformed and quantized, and then entropy encoded and transmitted in a bitstream, along with reconstructed frames, out to decoders or storage. To perform these operations, the LCEVC encoder 300 may receive an input frame from the input sequence 302. The input frames may be frames sufficiently pre-processed for encoding.

The LCEVC encoder 300 also may manage many encoding aspects including at least the setting of a quantization parameter (QP) but could also include setting bitrate, rate distortion or scene characteristics, prediction and/or transform partition or block sizes, available prediction mode types, and best mode selection parameters to name a few examples.

The output of the transformed and quantized data may be provided to the inverse transform and quantization to generate the same reference or reconstructed blocks, frames, or other units as would be generated at a decoder such as the LCEVC decoder 100. Thus, the prediction unit may use the inverse transform and quantization, adder, and filter to reconstruct the frames.

A prediction unit may perform inter-prediction including motion estimation and motion compensation, intra-prediction according to the description herein, and/or a combined inter-intra prediction. The prediction unit may select the best prediction mode (including intra-modes) for a particular block, typically based on bit-cost and other factors. The prediction unit may select an intra-prediction and/or inter-prediction mode when multiple such modes of each may be available. The prediction output of the prediction unit in the form of a prediction block may be provided both to the subtractor to generate a residual, and in the decoding loop to the adder to add the prediction to the reconstructed residual from the inverse transform to reconstruct a frame.

The partitioner or other initial units not shown may place frames in order for encoding and assign classifications to the frames, such as I-frame, B-frame, P-frame and so forth, where I-frames are intra-predicted. Otherwise, frames may be divided into slices (such as an I-slice) where each slice may be predicted differently. Thus, for HEVC or AV1 coding of an entire I-frame or I-slice, spatial or intra-prediction is used, and in one form, only from data in the frame itself.

In various implementations, the prediction unit may perform an intra block copy (IBC) prediction mode and a non-IBC mode operates any other available intra-prediction mode such as neighbor horizontal, diagonal, or direct coding (DC) prediction mode, palette mode, directional or angle modes, and any other available intra-prediction mode. Other video coding standards, such as HEVC or VP9 may have different sub-block dimensions but still may use the IBC search disclosed herein. It should be noted, however, that the foregoing are only example partition sizes and shapes, the present disclosure not being limited to any particular partition and partition shapes and/or sizes unless such a limit is mentioned or the context suggests such a limit, such as with the optional maximum efficiency size as mentioned. It should be noted that multiple alternative partitions may be provided as prediction candidates for the same image area as described below.

The prediction unit may select previously decoded reference blocks. Then comparisons may be performed to determine if any of the reference blocks match a current block being reconstructed. This may involve hash matching, SAD search, or other comparison of image data, and so forth. Once a match is found with a reference block, the prediction unit may use the image data of the one or more matching reference blocks to select a prediction mode. By one form, previously reconstructed image data of the reference block is provided as the prediction, but alternatively, the original pixel image data of the reference block could be provided as the prediction instead. Either choice may be used regardless of the type of image data that was used to match the blocks.

The predicted block then may be subtracted at subtractor from the current block of original image data, and the resulting residual may be partitioned into one or more transform blocks (TUs) so that the transform and quantization can transform the divided residual data into transform coefficients using discrete cosine transform (DCT) for example. Using the quantization parameter (QP) set by the LCEVC encoder 300, the transform and quantization then uses lossy resampling or quantization on the coefficients. The frames and residuals along with supporting or context data block size and intra displacement vectors and so forth may be entropy encoded by the LCEVCe encoder 300 and transmitted to decoders.

In one or more embodiments, the LCEVC decoder 100 may receive coded video data in the form of a bitstream and that has the image data (chroma and luma pixel values) and as well as context data including residuals in the form of quantized transform coefficients and the identity of reference blocks including at least the size of the reference blocks, for example. The context also may include prediction modes for individual blocks, other partitions such as slices, inter-prediction motion vectors, partitions, quantization parameters, filter information, and so forth. The LCEVC decoder 100 may process the bitstream with an entropy decoder to extract the quantized residual coefficients as well as the context data. The LCEVC decoder 100 then may use the inverse transform and quantization to reconstruct the residual pixel data.

The LCEVC decoder 100 then may use an adder (along with assemblers not shown) to add the residual to a predicted block. The LCEVC decoder 100 also may decode the resulting data using a decoding technique employed depending on the coding mode indicated in syntax of the bitstream, and either a first path including a prediction unit or a second path that includes a filter. The prediction unit performs intra-prediction by using reference block sizes and the intra displacement or motion vectors extracted from the bitstream, and previously established at the encoder. The prediction unit may utilize reconstructed frames as well as inter-prediction motion vectors from the bitstream to reconstruct a predicted block. The prediction unit may set the correct prediction mode for each block, where the prediction mode may be extracted and decompressed from the compressed bitstream.

In one or more embodiments, the coded data (e.g., the bitstream 102) may include both video and audio data.

It is understood that the above descriptions are for purposes of illustration and are not meant to be limiting.

FIG. 4 illustrates a flow diagram of an illustrative process 400 for LCEVC using tile-level quantization parameters, in accordance with one or more example embodiments of the present disclosure.

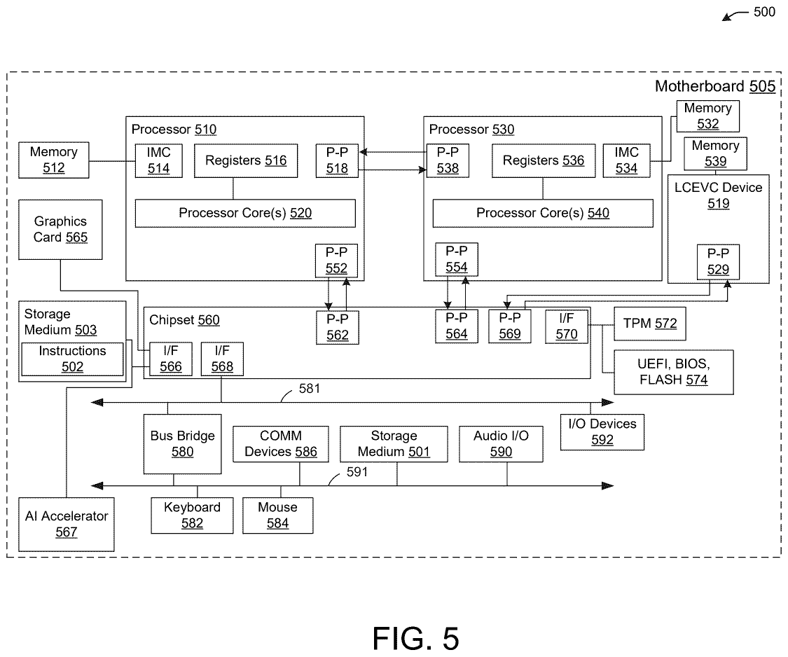

At block 402, a device (e.g., the LCEVC decoder 100 of FIG. 1, the graphics card 565 of FIG. 5, the LCEVC device 519 of FIG. 5) may identify a bitstream (e.g., the bitstream 102 of FIG. 1) encoded using a base encoder (e.g., the base layer data 104 of FIG. 1 of the encoded base 316 generated by the base encoder 314 of FIG. 1) and enhancement layers (e.g., the Layer-1 coefficient data 106 of FIG. 1 of the Layer-1 coefficient layers 334 of FIG. 3, the Layer-2 coefficient data 108 of FIG. 1 of the Layer-2 coefficient layers 350 of FIG. 3, the temporal data 110 of the temporal layer 354 of FIG. 3), and headers (e.g., the headers 112 of FIG. 1 and the headers 356 of FIG. 3). The syntax of the bitstream may include one or more indicators, including the delta_qp_per_tile_flag of Table 1B above in the global configuration for the bitstream, indicating a 0 bit for disabling tile-level QPs, and a 1 bit for enabling tile-level QPs as shown in Table 2 above. The indicators also may include tile-level QPs for each tile for each layer and each frame as shown above in Table 3.

At block 404, the device may decode a first video frame of the first layer of the bitstream using a base decoder (e.g., decode a frame having the base layer data 104 using the base layer decoder 116). The base decoder may be a non-LCEVC decoder (e.g., using a codec different than LCEVC).

At block 406, the device may up-sample the decoded first video frame (e.g., up-sample the decoded base layer frame 118 of FIG. 1 using the upscaler 120 of FIG. 1).

At block 408, the device may decode encoded video data of a first enhancement layer of the enhancement layers (e.g., decode the Layer-1 coefficient data 106 using the entropy decoding 124 of FIG. 1). The decoding may be based on the QPs used to encode the video frame, which may be tile-level QPs, allowing each tile to have its own QP that may be different from any other tile in the frame (e.g., as shown in FIG. 2B). The syntax of the bitstream may indicate whether the QPs are tile-level or frame level. When the QPs are tile-level (e.g., so that ROI tiles are encoded differently from non-ROI tiles in a same frame and/or from other ROI tiles in a same frame), the syntax may provide the QPs for each tile for each layer of a frame. The picture configuration of the syntax may indicate the step width parameter to be used in decoding the encoded residuals of the frame (e.g., as limited by a function to a range of values). Using the step width parameter, the QP for a tile may be based on the step width parameter, and the different tiles of a frame may be decoded based on their different QPs.

At block 410, the device may generate a first combined intermediate video frame (e.g., the combined intermediate frame 136 of FIG. 1) by combining the up-sampled first video frame and the decoded video data of the first enhancement layer.

At block 412, the device may up-sample the first combined intermediate video frame (e.g., using the upscaler 138 of FIG. 1).

At block 414, the device may decode encoded video data of a second enhancement layer of the enhancement layers (e.g., decode the Layer-2 coefficient data 108 using the entropy decoding 142 of FIG. 1). As noted for block 408, the QPs may be tile-level, so the QPs for each tile of the frame at the second enhancement layer may be signaled individually like the tiles at the first enhancement layer at block 408.

At block 416, the device may generate a second combined intermediate video frame (e.g., the combined intermediate frame 160 of FIG. 1) by combining the decoded video data of the second enhancement layer and a selected reference frame.

At block 418, the device may generate a combined output video frame (e.g., the combined output video frames 164 of FIG. 1) by combining the first combined intermediate video frame and the second combined intermediate video frame. Combined output video frames generated by the process 400 may represent the video frames used for playback. At block 420, the combined output video frames may be presented for playback.

It is understood that the above descriptions are for purposes of illustration and are not meant to be limiting.

FIG. 8 illustrates an embodiment of an exemplary system 500, in accordance with one or more example embodiments of the present disclosure.

In various embodiments, the computing system 500 may comprise or be implemented as part of an electronic device.

In some embodiments, the computing system 500 may be representative, for example, of a computer system that implements one or more components of FIG. 1 and FIG. 3.

The embodiments are not limited in this context. More generally, the computing system 500 is configured to implement all logic, systems, processes, logic flows, methods, equations, apparatuses, and functionality described herein and with reference to FIGS. 1-4.

The system 500 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 500 may have a single processor with one core or more than one processor. Note that the term “processor” refers to a processor with a single core or a processor package with multiple processor cores.

In at least one embodiment, the computing system 500 is representative of one or more components of FIG. 1 and FIG. 3. More generally, the computing system 500 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 500. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 500 comprises a motherboard 505 for mounting platform components. The motherboard 505 is a point-to-point interconnect platform that includes a processor 510, a processor 530 coupled via a point-to-point interconnects as an Ultra Path Interconnect (UPI), and a LCEVC device 519 (e.g., capable of performing the functions of FIGS. 1-4). In other embodiments, the system 500 may be of another bus architecture, such as a multi-drop bus. Furthermore, each of processors 510 and 530 may be processor packages with multiple processor cores. As an example, processors 510 and 530 are shown to include processor core(s) 520 and 540, respectively. While the system 500 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 510 and the chipset 560. Some platforms may include additional components and some platforms may only include sockets to mount the processors and/or the chipset.

The processors 510 and 530 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 510, and 530.

The processor 510 includes an integrated memory controller (IMC) 514 and point-to-point (P-P) interfaces 518 and 552. Similarly, the processor 530 includes an IMC 534 and P-P interfaces 538 and 554. The IMC's 514 and 534 couple the processors 510 and 530, respectively, to respective memories, a memory 512 and a memory 532. The memories 512 and 532 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 512 and 532 locally attach to the respective processors 510 and 530.

In addition to the processors 510 and 530, the system 500 may include the LCEVC device 519. The LCEVC device 519 may be connected to chipset 560 by means of P-P interfaces 529 and 569. The LCEVC device 519 may also be connected to a memory 539. In some embodiments, the LCEVC device 519 may be connected to at least one of the processors 510 and 530. In other embodiments, the memories 512, 532, and 539 may couple with the processor 510 and 530, and the LCEVC device 519 via a bus and shared memory hub.

System 500 includes chipset 560 coupled to processors 510 and 530. Furthermore, chipset 560 can be coupled to storage medium 503, for example, via an interface (I/F) 566. The I/F 566 may be, for example, a Peripheral Component Interconnect-enhanced (PCI-e). The processors 510, 530, and the LCEVC device 519 may access the storage medium 503 through chipset 560.

Storage medium 503 may comprise any non-transitory computer-readable storage medium or machine-readable storage medium, such as an optical, magnetic or semiconductor storage medium. In various embodiments, storage medium 503 may comprise an article of manufacture. In some embodiments, storage medium 503 may store computer-executable instructions, such as computer-executable instructions 502 to implement one or more of processes or operations described herein, (e.g., process 400 of FIG. 4). The storage medium 503 may store computer-executable instructions for any equations depicted above. The storage medium 503 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 510 couples to a chipset 560 via P-P interfaces 552 and 562 and the processor 530 couples to a chipset 560 via P-P interfaces 554 and 564. Direct Media Interfaces (DMIs) may couple the P-P interfaces 552 and 562 and the P-P interfaces 554 and 564, respectively. The DMI may be a high-speed interconnect that facilitates, e.g., eight Giga Transfers per second (GT/s) such as DMI 3.0. In other embodiments, the processors 510 and 530 may interconnect via a bus.

The chipset 560 may comprise a controller hub such as a platform controller hub (PCH). The chipset 560 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 560 may comprise more than one controller hub such as a chipset with a memory controller hub, a graphics controller hub, and an input/output (I/O) controller hub.

In the present embodiment, the chipset 560 couples with a trusted platform module (TPM) 572 and the UEFI, BIOS, Flash component 574 via an interface (I/F) 570. The TPM 572 is a dedicated microcontroller designed to secure hardware by integrating cryptographic keys into devices. The UEFI, BIOS, Flash component 574 may provide pre-boot code.

Furthermore, chipset 560 includes the I/F 866 to couple chipset 560 with a high-performance graphics engine, graphics card 565. In other embodiments, the system 500 may include a flexible display interface (FDI) between the processors 510 and 530 and the chipset 560. The FDI interconnects a graphics processor core in a processor with the chipset 560.

Various I/O devices 592 couple to the bus 581, along with a bus bridge 580 which couples the bus 581 to a second bus 591 and an I/F 868 that connects the bus 581 with the chipset 560. In one embodiment, the second bus 591 may be a low pin count (LPC) bus. Various devices may couple to the second bus 591 including, for example, a keyboard 582, a mouse 584, communication devices 586, a storage medium 501, and an audio I/O 590.

The artificial intelligence (AI) accelerator 567 may be circuitry arranged to perform computations related to AI. The AI accelerator 567 may be connected to storage medium 503 and chipset 560. The AI accelerator 567 may deliver the processing power and energy efficiency needed to enable abundant-data computing. The AI accelerator 567 is a class of specialized hardware accelerators or computer systems designed to accelerate artificial intelligence and machine learning applications, including artificial neural networks and machine vision. The AI accelerator 567 may be applicable to algorithms for robotics, internet of things, other data-intensive and/or sensor-driven tasks.

Many of the I/O devices 592, communication devices 586, and the storage medium 501 may reside on the motherboard 505 while the keyboard 582 and the mouse 584 may be add-on peripherals. In other embodiments, some or all the I/O devices 592, communication devices 586, and the storage medium 501 are add-on peripherals and do not reside on the motherboard 505.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. Integrated circuits, processor packages, chip packages, and chipsets may comprise one or more processors.

Processors may receive signals such as instructions and/or data at the input(s) and process the signals to generate at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.
Example 1 may be an apparatus for decoding video data encoded using low-complexity enhancement video coding (LCEVC), the apparatus comprising processing circuitry coupled to memory, the processing circuitry configured to: identify a bitstream received from a device, the bitstream comprising a first layer encoded using a base encoder and enhancement layers encoded using LCEVC; decode a first video frame of the first layer of the bitstream using a base decoder; up-sample the decoded first video frame; identify a first quantization parameter of a first tile of the first video frame encoded using a first enhancement layer of the enhancement layers; identify a second quantization parameter of a second tile of the first video frame encoded using the first enhancement layer, the second quantization parameter different than the first quantization parameter; decode, based on the first quantization parameter and the second quantization parameter, the first video frame encoded using the first enhancement layer; generate a first combined intermediate video frame by combining the up-sampled first video frame and the decoded first video frame encoded using the first enhancement layer; up-sample the first combined intermediate video frame; decode the first video frame encoded using a second enhancement layer of the enhancement layers; generate a second combined intermediate video frame by combining the decoded first video frame encoded using the second enhancement layer and a reference frame; and generate a combined output video frame by combining the first combined intermediate video frame and the second combined intermediate video frame.
Example 2 may include the apparatus of example 1 and/or any other example herein, wherein the processing circuitry is further configured to: identify a third quantization parameter of a third tile of the first video frame encoded using the second enhancement layer; and identify a fourth quantization parameter of a fourth tile of the first video frame encoded using the second enhancement layer, the fourth quantization parameter different than the second quantization parameter, wherein to decode the first video frame encoded using the second enhancement layer is based on the third quantization parameter and the fourth quantization parameter.
Example 3 may include the apparatus of example 1 and/or any other example herein, wherein the processing circuitry is further configured to: identify a global configuration syntax of the bitstream; identify a tile-level quantization parameter indicator in the global configuration syntax; and determine that the level quantization parameter indicator indicates that the first tile and the second tile have separate quantization parameters.
Example 4 may include the apparatus of example 3 and/or any other example herein, wherein the processing circuitry is further configured to: identify a process payload of a picture configuration of the bitstream; and identify, in the process payload, quantization parameters for layers of the first video frame encoded using the first enhancement layer, the quantization parameters comprising the first quantization parameter and the second quantization parameter.
Example 5 may include the apparatus of any of examples 1-3 and/or any other example herein, wherein the first quantization parameter is based on a first step width quantization step size for the first tile, and wherein the second quantization parameter is based on a second step width quantization step size for the second tile.
Example 6 may include the apparatus of example 5 and/or any other example herein, wherein the first step width quantization step size and the second step width quantization step size are based on a function limited to a range of 0 to 215-1.
Example 7 may include the apparatus of example 5 and/or any other example herein, wherein the processing circuitry is further configured to: store step width quantization step sizes of each layer and each tile for each level of residuals of the first video frame.
Example 8 may include the apparatus of example 1 and/or any other example herein, wherein the first tile is associated with a region of interest representing at least a portion of an object, wherein the second tile is unassociated with the region of interest, and wherein the first quantization parameter is less than the second quantization parameter based on the first tile being associated with the region of interest.
Example 9 may include a computer-readable storage medium comprising instructions to cause processing circuitry of a device for decoding video data encoded using low-complexity enhancement video coding (LCEVC), upon execution of the instructions by the processing circuitry, to: identify a bitstream received from a device, the bitstream comprising a first layer encoded using a base encoder and enhancement layers encoded using LCEVC; decode a first video frame of the first layer of the bitstream using a base decoder; up-sample the decoded first video frame; identify a first quantization parameter of a first tile of the first video frame encoded using a first enhancement layer of the enhancement layers; identify a second quantization parameter of a second tile of the first video frame encoded using the first enhancement layer, the second quantization parameter different than the first quantization parameter; decode, based on the first quantization parameter and the second quantization parameter, the first video frame encoded using the first enhancement layer; generate a first combined intermediate video frame by combining the up-sampled first video frame and the decoded first video frame encoded using the first enhancement layer; up-sample the first combined intermediate video frame; decode the first video frame encoded using a second enhancement layer of the enhancement layers; generate a second combined intermediate video frame by combining the decoded first video frame encoded using the second enhancement layer and a reference frame; and generate a combined output video frame by combining the first combined intermediate video frame and the second combined intermediate video frame.
Example 10 may include the computer-readable medium of example 9 and/or any other example herein, wherein execution of the instructions further causes the processing circuitry to: identify a third quantization parameter of a third tile of the first video frame encoded using the second enhancement layer; and identify a fourth quantization parameter of a fourth tile of the first video frame encoded using the second enhancement layer, the fourth quantization parameter different than the second quantization parameter, wherein to decode the first video frame encoded using the second enhancement layer is based on the third quantization parameter and the fourth quantization parameter.
Example 11 may include the computer-readable medium of example 9 and/or any other example herein, wherein execution of the instructions further causes the processing circuitry to: identify a global configuration syntax of the bitstream; identify a tile-level quantization parameter indicator in the global configuration syntax; and determine that the level quantization parameter indicator indicates that the first tile and the second tile have separate quantization parameters.
Example 12 may include the computer-readable medium of example 11 and/or any other example herein, wherein execution of the instructions further causes the processing circuitry to: identify a process payload of a picture configuration of the bitstream; and identify, in the process payload, quantization parameters for layers of the first video frame encoded using the first enhancement layer, the quantization parameters comprising the first quantization parameter and the second quantization parameter.
Example 13 may include the computer-readable medium of examples 9-11 and/or any other example herein, wherein the first quantization parameter is based on a first step width quantization step size for the first tile, and wherein the second quantization parameter is based on a second step width quantization step size for the second tile.
Example 14 may include the computer-readable medium of example 13 and/or any other example herein, wherein the first step width quantization step size and the second step width quantization step size are based on a function limited to a range of 0 to 215-1.
Example 15 may include the computer-readable medium of example 14 and/or any other example herein, store step width quantization step sizes of each layer and each tile for each level of residuals of the first video frame.
Example 16 may include the computer-readable medium of example 9 and/or any other example herein, wherein the first tile is associated with a region of interest representing at least a portion of an object, wherein the second tile is unassociated with the region of interest, and wherein the first quantization parameter is less than the second quantization parameter based on the first tile being associated with the region of interest.
Example 17 may include a method for decoding video data encoded using low-complexity enhancement video coding (LCEVC), the method comprising: identifying, by at least one processor of a first device, a bitstream received from a second device, the bitstream comprising a first layer encoded using a base encoder and enhancement layers encoded using LCEVC; decoding, by the least one processor, a first video frame of the first layer of the bitstream using a base decoder; up-sampling, by the least one processor, the decoded first video frame; identifying, by the least one processor, a first quantization parameter of a first tile of the first video frame encoded using a first enhancement layer of the enhancement layers; identifying, by the least one processor, a second quantization parameter of a second tile of the first video frame encoded using the first enhancement layer, the second quantization parameter different than the first quantization parameter; decoding, by the least one processor, based on the first quantization parameter and the second quantization parameter, the first video frame encoded using the first enhancement layer; generating, by the least one processor, a first combined intermediate video frame by combining the up-sampled first video frame and the decoded first video frame encoded using the first enhancement layer; up-sampling, by the least one processor, the first combined intermediate video frame; decoding, by the least one processor, the first video frame encoded using a second enhancement layer of the enhancement layers; generating, by the least one processor, a second combined intermediate video frame by combining the decoded first video frame encoded using the second enhancement layer and a reference frame; and generating, by the least one processor, a combined output video frame by combining the first combined intermediate video frame and the second combined intermediate video frame.
Example 18 may include the method of example 17 and/or any other example herein, further comprising: identifying a third quantization parameter of a third tile of the first video frame encoded using the second enhancement layer; and identifying a fourth quantization parameter of a fourth tile of the first video frame encoded using the second enhancement layer, the fourth quantization parameter different than the second quantization parameter, wherein decoding the first video frame encoded using the second enhancement layer is based on the third quantization parameter and the fourth quantization parameter.
Example 19 may include the method of example 18 and/or any other example herein, further comprising: identifying a global configuration syntax of the bitstream; identifying a tile-level quantization parameter indicator in the global configuration syntax; and determining that the level quantization parameter indicator indicates that the first tile and the second tile have separate quantization parameters.
Example 20 may include the method of example 19 and/or any other example herein, further comprising: identifying a process payload of a picture configuration of the bitstream; and identifying, in the process payload, quantization parameters for layers of the first video frame encoded using the first enhancement layer, the quantization parameters comprising the first quantization parameter and the second quantization parameter.
Example 21 may include the method of any of examples 17-19 and/or any other example herein, wherein the first quantization parameter is based on a first step width quantization step size for the first tile, and wherein the second quantization parameter is based on a second step width quantization step size for the second tile.
Example 22 may include the example of claim 21 and/or any other example herein, wherein the first step width quantization step size and the second step width quantization step size are based on a function limited to a range of 0 to 215-1.
Example 23 may include the method of example 21 and/or any other example herein, further comprising: storing step width quantization step sizes of each layer and each tile for each level of residuals of the first video frame.
Example 24 may include the method of example 17 and/or any other example herein, wherein the first tile is associated with a region of interest representing at least a portion of an object, wherein the second tile is unassociated with the region of interest, and wherein the first quantization parameter is less than the second quantization parameter based on the first tile being associated with the region of interest.
Example 25 may include an apparatus comprising means for performing any of the methods of examples 17-24.
Example 26 may include one or more non-transitory computer-readable media comprising instructions to cause an electronic device, upon execution of the instructions by one or more processors of the electronic device, to perform one or more elements of a method described in or related to any of examples 1-25, or any other method or process described herein.
Example 27 may include an apparatus comprising logic, modules, and/or circuitry to perform one or more elements of a method described in or related to any of examples 1-25, or any other method or process described herein.
Example 28 may include a method, technique, or process as described in or related to any of examples 1-25, or portions or parts thereof.
Example 29 may include an apparatus comprising: one or more processors and one or more computer readable media comprising instructions that, when executed by the one or more processors, cause the one or more processors to perform the method, techniques, or process as described in or related to any of examples 1-25, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1-25. (canceled)

26. An apparatus to decode video data, the apparatus comprising:
memory;
instructions; and
at least one processor circuit to be programmed based on the instructions to:
identify a bitstream from a device, the bitstream including a first layer encoded using a base encoder and enhancement layers encoded using low-complexity enhancement video coding (LCEVC);
decode a first video frame of the first layer of the bitstream using a base decoder;
up-sample the decoded first video frame;
identify a first quantization parameter of a first tile of the first video frame encoded using a first enhancement layer of the enhancement layers;
identify a second quantization parameter of a second tile of the first video frame encoded using the first enhancement layer, the second quantization parameter different than the first quantization parameter;
decode, based on the first quantization parameter and the second quantization parameter, the first video frame encoded using the first enhancement layer;
generate a first combined intermediate video frame based on the up-sampled first video frame and the decoded first video frame encoded using the first enhancement layer;
up-sample the first combined intermediate video frame;
decode the first video frame encoded using a second enhancement layer of the enhancement layers;
generate a second combined intermediate video frame based on the decoded first video frame encoded using the second enhancement layer and a reference frame; and
generate a combined output video frame based on the first combined intermediate video frame and the second combined intermediate video frame.

27. The apparatus of claim 26, wherein one or more of the at least one processor circuit is to:
identify a third quantization parameter of a third tile of the first video frame encoded using the second enhancement layer;
identify a fourth quantization parameter of a fourth tile of the first video frame encoded using the second enhancement layer, the fourth quantization parameter different than the second quantization parameter; and
decode the first video frame encoded using the second enhancement layer based on the third quantization parameter and the fourth quantization parameter.

28. The apparatus of claim 26, wherein one or more of the at least one processor circuit is to:
identify a global configuration syntax of the bitstream;
identify a tile-level quantization parameter indicator in the global configuration syntax; and
determine that the tile-level quantization parameter indicator indicates that the first tile and the second tile have separate quantization parameters.

29. The apparatus of claim 28, wherein one or more of the at least one processor circuit is to:
identify a process payload of a picture configuration of the bitstream; and
identify, in the process payload, quantization parameters for layers of the first video frame encoded using the first enhancement layer, the quantization parameters including the first quantization parameter and the second quantization parameter.

30. The apparatus of claim 26, wherein the first quantization parameter is based on a first step width quantization step size for the first tile, and the second quantization parameter is based on a second step width quantization step size for the second tile.

31. The apparatus of claim 30, wherein the first step width quantization step size and the second step width quantization step size are based on a function limited to a range of 0 to 215-1.

32. The apparatus of claim 30, wherein one or more of the at least one processor circuit is to:
store step width quantization step sizes of each layer and each tile for each level of residuals of the first video frame.

33. The apparatus of claim 26, wherein the first tile is associated with a region of interest representing at least a portion of an object, the second tile is unassociated with the region of interest, and the first quantization parameter is less than the second quantization parameter based on the first tile being associated with the region of interest.

34. A non-transitory computer-readable storage medium comprising instructions to cause at least one processor circuit to at least:
identify a bitstream from a device, the bitstream including a first layer encoded using a base encoder and enhancement layers encoded using low-complexity enhancement video coding (LCEVC);
decode a first video frame of the first layer of the bitstream using a base decoder;
up-sample the decoded first video frame;
identify a first quantization parameter of a first tile of the first video frame encoded using a first enhancement layer of the enhancement layers;
identify a second quantization parameter of a second tile of the first video frame encoded using the first enhancement layer, the second quantization parameter different than the first quantization parameter;
decode, based on the first quantization parameter and the second quantization parameter, the first video frame encoded using the first enhancement layer;
generate a first combined intermediate video frame based on the up-sampled first video frame and the decoded first video frame encoded using the first enhancement layer;
up-sample the first combined intermediate video frame;
decode the first video frame encoded using a second enhancement layer of the enhancement layers;
generate a second combined intermediate video frame based on the decoded first video frame encoded using the second enhancement layer and a reference frame; and
generate a combined output video frame based on the first combined intermediate video frame and the second combined intermediate video frame.

35. The computer-readable medium of claim 34, wherein the instructions are to cause one or more of the at least one processor circuit to:
identify a third quantization parameter of a third tile of the first video frame encoded using the second enhancement layer;
identify a fourth quantization parameter of a fourth tile of the first video frame encoded using the second enhancement layer, the fourth quantization parameter different than the second quantization parameter; and
decode the first video frame encoded using the second enhancement layer based on the third quantization parameter and the fourth quantization parameter.

36. The computer-readable medium of claim 34, wherein the instructions are to cause one or more of the at least one processor circuit to:
identify a global configuration syntax of the bitstream;
identify a tile-level quantization parameter indicator in the global configuration syntax; and
determine that the tile-level quantization parameter indicator indicates that the first tile and the second tile have separate quantization parameters.

37. The computer-readable medium of claim 36, wherein the instructions are to cause one or more of the at least one processor circuit to:
identify a process payload of a picture configuration of the bitstream; and
identify, in the process payload, quantization parameters for layers of the first video frame encoded using the first enhancement layer, the quantization parameters including the first quantization parameter and the second quantization parameter.

38. The computer-readable medium of claim 34, wherein the first quantization parameter is based on a first step width quantization step size for the first tile, and the second quantization parameter is based on a second step width quantization step size for the second tile.

39. The computer-readable medium of claim 34, wherein the first tile is associated with a region of interest representing at least a portion of an object, the second tile is unassociated with the region of interest, and the first quantization parameter is less than the second quantization parameter based on the first tile being associated with the region of interest.

40. A method for decoding video data, the method comprising:
identifying, by at least one processor circuit of a first device, a bitstream from a second device, the bitstream including a first layer encoded using a base encoder and enhancement layers encoded using low-complexity enhancement video coding (LCEVC);
decoding, by one or more of the at least one processor circuit, a first video frame of the first layer of the bitstream using a base decoder;
up-sampling, by one or more of the at least one processor circuit, the decoded first video frame;
identifying, by one or more of the at least one processor circuit, a first quantization parameter of a first tile of the first video frame encoded using a first enhancement layer of the enhancement layers;
identifying, by one or more of the at least one processor circuit, a second quantization parameter of a second tile of the first video frame encoded using the first enhancement layer, the second quantization parameter different than the first quantization parameter;
decoding, by one or more of the at least one processor circuit, based on the first quantization parameter and the second quantization parameter, the first video frame encoded using the first enhancement layer;
generating, by one or more of the at least one processor circuit, a first combined intermediate video frame based on the up-sampled first video frame and the decoded first video frame encoded using the first enhancement layer;
up-sampling, by one or more of the at least one processor circuit, the first combined intermediate video frame;
decoding, by one or more of the at least one processor circuit, the first video frame encoded using a second enhancement layer of the enhancement layers;
generating, by one or more of the at least one processor circuit, a second combined intermediate video frame based on the decoded first video frame encoded using the second enhancement layer and a reference frame; and
generating, by one or more of the at least one processor circuit, a combined output video frame based on the first combined intermediate video frame and the second combined intermediate video frame.

41. The method of claim 40, including:
identifying a third quantization parameter of a third tile of the first video frame encoded using the second enhancement layer; and
identifying a fourth quantization parameter of a fourth tile of the first video frame encoded using the second enhancement layer, the fourth quantization parameter different than the second quantization parameter,
wherein the decoding of the first video frame encoded using the second enhancement layer is based on the third quantization parameter and the fourth quantization parameter.

42. The method of claim 41, including:
identifying a global configuration syntax of the bitstream;
identifying a tile-level quantization parameter indicator in the global configuration syntax; and
determining that the tile-level quantization parameter indicator indicates that the first tile and the second tile have separate quantization parameters.

43. The method of claim 42, including:
identifying a process payload of a picture configuration of the bitstream; and
identifying, in the process payload, quantization parameters for layers of the first video frame encoded using the first enhancement layer, the quantization parameters including the first quantization parameter and the second quantization parameter.

44. The method of claim 40, wherein the first quantization parameter is based on a first step width quantization step size for the first tile, and the second quantization parameter is based on a second step width quantization step size for the second tile.

45. The method of claim 40, wherein the first tile is associated with a region of interest representing at least a portion of an object, the second tile is unassociated with the region of interest, and the first quantization parameter is less than the second quantization parameter based on the first tile being associated with the region of interest.
